(19) United States
(12) Patent Application Publication
(10) Pub. No.: US 2024/0113618 A1
(43) Pub. Date: Apr. 4, 2024

(54) DC-DC Converter with Dynamic MPPT

(71) Applicant: NEXPERIA B.V., Nijmegen (NL)

(72) Inventors: Gustavo CAMPOS MARTINS, Delft (NL); Luc VAN WIETMARSCHEN, Delft (NL); Samaneh Babayan MASHHADI, Delft (NL); Mohammadjavad DEZYANI, Delft (NL)

(73) Assignee: NEXPERIA B.V., Nijmegen (NL)

(21) Appl. No.: 18/540,210

(22) Filed: Dec. 14, 2023

Related U.S. Application Data
(63) Continuation of application No. PCT/NL2022/050344, filed on Jun. 17, 2022.

(30) Foreign Application Priority Data
Jun. 17, 2021 (NL) 2028470

(51) Int. Cl. H02M 3/04

(52) U.S. Cl. CPC H02M 3/04

(57) ABSTRACT

According to an aspect of the present disclosure, an electrical power converter unit for converting Direct Current to Direct Current (DC-DC) is provided. Specifically, an improved electrical power converter unit for converting DC-DC is provided which applies a MPPT mechanism which is both efficient and allows flexibility in use.

### CROSS-REFERENCE TO RELATED APPLICATIONS

This application is a continuation of International Application No. PCT/NL2022/050344 filed on Jun. 17, 2022, which claims priority to Netherlands Patent Application No. NL2028470 filed on Jun. 17, 2021, both of which are hereby incorporated herein by reference in their entirety.

### BACKGROUND

### Field of the Disclosure

The present disclosure relates, in general, to an electrical power converter unit for converting Direct Current to Direct Current, DC-DC, and more particular to a DC-DC converter which applies a dynamic Maximum Power Point Tracking, MPPT, mechanism.

### Description of the Related Art

An electrical power converter converts electric energy from one form to another form, e.g. from an Alternating Current, AC, to a Direct Current, DC. Electrical power converters may also convert a voltage level or a frequency or a combination thereof. The present disclosure relates in particular to DC-DC converters. Particularly in application which are low-power driven, such as Internet-of-Tings, IoT, sensors or portable and wearable devices, efficient conversion of energy from a particular energy source is very important. Especially when the energy is harvested and derived from external sources such as solar power, thermal energy, wind energy, salinity gradients, or ambient energy, the efficiency in converting the energy to the requirements of the particular application becomes even more important.

MPPT is a mechanism which is commonly used in DC-DC converters where the energy is harvested and derived from external sources. MPPT is for example widely used in photovoltaic solar systems.

In photovoltaic solar systems the energy levels typically vary over time as during the day, and over seasonal variations the amount of sunlight impinging the solar panel varies. Not only the amount of sunlight differs, but also the temperature of the solar panel and the other components of the system, which influence the electrical characteristics of the system and the load. The energy conversion is most efficient when the load is matched to the power supply. With an MPPT a control mechanism is applied to optimize this match under such changes in variation within the system.

In the application of a MPPT mechanism there is always a trade-off between the increase in efficiency in the power conversion versus the impact, complexity and power consumption of the MPPT mechanism itself. Especially in low-power applications where the energy harvested it is challenging to find an optimum. DC-DC converters which have dedicated MPPT mechanisms may be very efficient for a particular application but are not very flexible in use whereas more general MPPT mechanisms may be used for a variety of applications but may not be as efficient.

In view of the above, there is a need for an improved electrical power converter unit for converting Direct Current to Direct Current, DC-DC, which applies a MPPT mechanism which is both efficient and allows flexibility in use.

### SUMMARY

According to a first aspect of the present disclosure, an electrical power converter unit for converting Direct Current to Direct Current, DC-DC comprises:
a DC-DC converting module, arranged for converting a low-power direct current input signal received from an energy harvesting module such as an RF energy harvesting module, into a direct current output signal for powering a load, such as an internet-of-things sensor module;
a controller module, operably coupled to and arranged for controlling said DC-DC module, and arranged for converting said direct current input signal to said direct current output signal according to a Maximum Power Point Tracking, MPPT, profile, and wherein said controller module comprises a memory for storing said MPPT profile as well as at least a further MPPT profile;
a sensor module, operably coupled to controller module, and said direct current output of said DC-DC converter module, and arranged for measuring the direct current output to said load;
a communication interface, operably coupled to said controller module, arranged to interface with a micro-controller external from said electrical power energy converter unit, for receiving a command signal thereof, wherein said command signal defines which of said MPPT profile and at least one further MPPT profile selected, for said controller module to operate said DC-DC converting module according to said selected MPPT profile.

Electric power units or power converters in short, are arranged to convert an input voltage to a certain output voltage. In accordance with the present disclosure, a Direct Current, DC, voltage to a DC output at a different voltage. The conversion ratio between the input and output voltage level is determined by the configuration of the converter and is limited to a certain amount. The voltage level can only be converted by a maximum ratio. Such a high ratio is often required if the energy source provides a very low, e.g. mV, voltage level, and the load requires much higher levels, e.g. 1V to 5V, which may be typical for Internet-of-Things, IoT, devices and Wireless Sensor Nodes, WSNs which may be powered, e.g. as an auxiliary power source, by an energy harvester.

Especially for IoT or WSN applications that are powered by energy harvesters require high conversion factors or ratio's as well as a high level of efficiency in converting the input power to the output power. Such energy harvesting based energy sources like environmental energy, solar energy, vibrational energy, thermal energy and Radio Frequency energy produce little energy and are also often highly inconsistent because they may vary depending on the time and operational conditions.

To increase efficiency in power conversion in energy harvesting based power converter units, Maximum Power Point Tracking, MPPT, may be applied.

MPPT may be applied in numerous methods and are mostly known in solar applications. The requirements and operational conditions for solar applications however differ significantly from RF based energy harvesting applications. In the RF based applications the impact of implementing and performing a MPPT routine may even require more energy than the increase of efficiency in energy conversion from applying the MPPT routine. In other applications however the advantage of applying a MPPT routine outweighs its drawbacks.

Accordingly, each energy converting unit that applies a MPPT, has a MPPT routine or algorithm that is specifically optimized for a certain application, e.g. solar, RF, thermal, etc. That implies that each application requires a specifically designed energy converter to cope with such a MPPT routine, for example by setting the maximum or minimum voltage swing, switching frequency, feedback circuit, etc. As a consequence, it is challenging to design an energy converting unit applying MPPT which is optimized for a wide variety of applications without either significantly increasing the bill of materials and complexity of design, or the use of (relatively to the application) high energy demanding (general purpose) processors to implement and control all variables of the MPPT algorithm.

It has been the insight of the inventors that a controller module should be used which is arranged to control the energy converting module according to a (first) MPPT profile, but also has a memory or is coupled to a memory to obtain, from such memory, a further (stored) MPPT profile which differs from the first MPPT profile, e.g. in applying a different switching frequency, conversion ratio, number of parallel operating power switches, resistor value of the sensor module, MPPT interval, overcurrent value or threshold and undercurrent value or threshold of the DC-DC converter module.

The controller module thus may at least be able to switch between two, but preferably multiple MPPT profiles. The selecting of the profiles is preferably not performed by the controller module itself, i.e. not within the converting module, but from an external source outside of the energy converter itself. To this end, the energy converter is provided with a communication interface that is operably coupled to the controller module and arranged to interface with a micro-controller external from the electrical power energy converter unit. The controller module may receive a command signal thereof, wherein the command signal defines which of the MPPT profiles, i.e. (first) MPPT profile, further MPPT profile or profiles, are selected such that the converting module which actually converts the input voltage to the output voltage, does so according to the MPPT profile that is being selected.

With the proposed design, a DC-DC energy converter is provided which on one hand does not depend on high energy consuming processors which dynamically sample and control the DC-DC converting unit to convert the input voltage to the output voltage according to a particular predefined MPPT routine, and on the other hand is not limited to increase the energy converting efficiency only for a small range of applications.

With the proposed design, a single, multi-purpose energy converter may be designed which is not only suitable for, but also arranged to be configured according to a MPPT profile which is optimal for a particular application once the energy converter is put in use. Hence, the energy converter may be optimized during operation instead of at the design stage.

Due to the communication interface it is further possible to implement future MPPT profiles which have even further improved efficiency for a particular application without the need to replace any modules of the controller, DC-DC converter or the energy converter as a whole, or even the total device.

In an example, the controller module is arranged to receive a command signal through said interface which command signal comprises said at least one further MPPT profile, for storing said at least one further MPPT profile in said memory of said controller module.

Upon operation, the energy converter may be arranged to apply a certain pre-selected MPPT profile, and further comprises a memory for storing at least one further MPPT profile. The further MPPT profile may be pre-loaded into the memory and thus be provided at manufacturing of the device, but in an example, the controller module may also be arranged to receive the further MPPT profile from an external device such as a micro-controller which interfaces with the energy converter for loading the one or more further MPPT profiles into the controller or the controllers memory.

In an example, the controller module comprises a MPPT state machine for operating said selected MPPT profile.

The controller may be configured to operate the MPPT profile as a finite automata. With the finite automata or state machine the controller may make decisions within the MPPT profile to change any of the variables within the profile or the even change between one or multiple profiles. In general the state machine may be implemented in a way to have several operational conditions such as a power-off condition, a start-up condition, a test condition, a sample condition, configure condition and a sleep condition. Depending on the MPPT profile the state machine may comprise transitions between states of the state machine based on variables within the profile and/or based on data obtained from the sensor module.

In an example, the memory of said controller module comprises a plurality of MPPT profiles for operating said DC-DC converter modules, each of said MPPT profiles providing an application specific operation of said electrical power energy converter unit.

The memory of the controller may be arranged for and comprise several MPPT profiles wherein each of the profiles is specifically designed for a particular application, e.g. RF or motion energy harvesting, or even for differentiations within a particular application, e.g. during day or night. As such, the device is suitable and optimized for all or at least a large number of applications without the need to redesign the device. Once the device is in operation, the most suitable profiles may be selected which selection is provided through a control signal that is received externally through the communication interface.

In an example, the MPPT profiles are arranged to change the operating of said DC-DC converter module by changing one or more of:
a switching frequency of said DC-DC converter module,
a conversion ratio of said DC-DC converter module,
a number of parallel operating power switches comprised in said DC-DC converter module,
a resistor value of a resistor comprised in said sensor module;
a MPPT interval;
an overcurrent value;
an undercurrent value.

In an example, the controller module is arranged for dynamically adapting a MPPT profile according to which said DC-DC converter is operated, wherein said controller module is arranged to receive one or more of:
a switching frequency of said DC-DC converter module,
a conversion ratio of said DC-DC converter module,
a number of parallel operating power switches comprised in said DC-DC converter module,
a resistor value of a resistor comprised in said sensor module;
a MPPT interval;
an overcurrent value;
an undercurrent value.

In an example, the controller module is arranged to output to a micro-controller connected to said controller module one or more of:
a switching frequency of said DC-DC converter module,
a conversion ratio of said DC-DC converter module,
a number of parallel operating power switches comprised in said DC-DC converter module,
a resistor value of a resistor comprised in said sensor module;
a MPPT interval;
an overcurrent value;
an undercurrent value.

The above mentioned examples provide several possibilities to pre-load MPPT profiles into the memory in which the profiles differ on one or more of the above mentioned variables such as switching frequency or output resistor sensor sampling, as well as provide a mechanism to fixate certain variables, or allow dynamic control of one or more of the variables. In yet another example, one or more of these variables may even be communicated to an external controller, i.e. a micro-controller connected to the controller module, such that the dynamic operation of the profile or variables within the profile may be controlled externally. Such external control may be done incidentally or even once directly after manufacturing to configure the device for a particular application, or may be done when in use. In yet a further example, the controller module is arranged to provide control over one or more of the variables on a dynamic manner to an external controller such as a (general) controller which is already present on the chip or on the PCB of the device wherein the energy converter is implemented (e.g. a wireless sensor node or IoT device).

In an example, the electrical power energy converter unit further comprising:
an Analogue to Digital Converter, ADC, operably coupled to said controller module and said sensor module for readout of said sensor module by said controller module and outputting said readout to a micro-controller connected to said controller module.

With the ADC the device is enabled to communicate any of the sensor data directly to an external device like a micro-controller which is incidentally or permanently connected to the controller module of the energy converter. That way the operating of the variables within the profile or the switching between profiles may be under control of the external micro-controller which selection is done based on sensor data obtained via the controller module.

In an example, the controller module is arranged to operate said DC-DC converter according to a MPPT profile in which said MPPT is bypassed.

The above-mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 shows a schematic overview of an embodiment of the electrical power converter unit according to the present disclosure.

FIG. 2 shows a schematic overview of another embodiment of the electrical power converter according to the present disclosure.

FIG. 3 shows a schematic overview of an event-based trigger of an electrical power converter according to the present disclosure.

FIG. 4 shows a look-up table for use by an MPPT algorithm of the event-based trigger of FIG. 3.

FIG. 5 shows a flow chart of an MPPT algorithm of the event-based trigger of FIG. 3.

FIG. 6 shows a schematic overview of elements of an embodiment of the electrical power converter using the event-based trigger of FIG. 3.

FIG. 7 shows a schematic overview of elements of another embodiment of the electrical power converter using the event-based trigger of FIG. 3.

### DETAILED DESCRIPTION

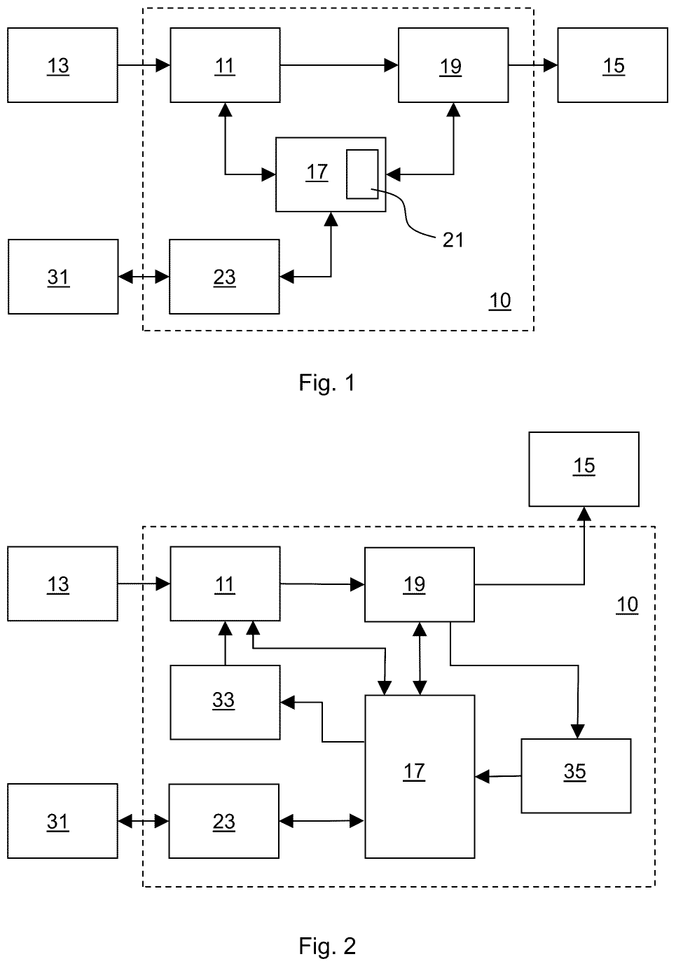

FIG. 1 shows a schematic overview of an embodiment of the electrical power converter unit 10 according to the present disclosure. The electrical power converter unit 10 is arranged for converting a low-power direct current input signal received from an energy harvesting module 13, such as an RF or solar energy harvesting module, into a direct current output signal for powering a load 15, such as an internet-of-things, IoT, sensor or an Wireless Sensor Nodes, WSNs. In IoT devices and WSNs, the energy harvesting module typically provides a very low, e.g. mV, voltage level which needs to be converted to much higher levels, e.g. 1V to 5V, suitable for the load 15.

The electrical power converter unit 10 comprises a DC-DC converting module 11, arranged for converting the low-power direct current input signal into the direct current output signal, and a sensor module 19 coupled to direct current output of the DC-DC converter module 11. The sensor module 19 is arranged for measuring the direct current output to the load 15, for example by measuring the voltage drop across a resistor comprised in the sensor module 19.

The electrical power converter unit 10 further comprises a controller module 17. The controller module 17 is operably coupled to the DC-DC converting module 11 and the sensor module 19. The controller module 17 is arranged for controlling the DC-DC module 11 such that the low-power direct current input signal is converted into the direct current output signal according to a Maximum Power Point Tracking, MPPT, profile. The controller module 17 comprises a memory 21 for storing a number MPPT profiles.

The MPPT applied by the energy converting unit 10, has a MPPT routine or algorithm that is specifically optimized for a certain energy harvesting application and energy harvesting module 13. The MPPT routine or algorithm is defined by the specific MPPT profile stored in the memory 21 of the controller module 17. The MPPT profile changes the operating of the DC-DC converter module 11 by changing one or more MPPT profile parameters of the DC-DC converter module 11, wherein the MPPT profile parameters are a switching frequency of the DC-DC converter module 11, a conversion ratio of the DC-DC converter module 11, a number of parallel operating power switches comprised in the DC-DC converter module 11, a resistor value of the resistor comprised in the sensor module 19, a MPPT interval, an overcurrent value and an undercurrent value.

Each MPPT profile provides an application specific operation of the electrical power energy converter unit 10. Furthermore, the controller module 17 can operate the DC-DC converter module 11 according to a MPPT profile in which the MPPT is bypassed. The MPPT can for example be bypassed by the controller module 17 such that no power is dissipated by the controller module 17, and/or changing the resistor value of the resistor comprised in the sensor module 19 such that no power is dissipated in the sensor module 19.

The electrical power converter unit 10 is operably coupled, via a communication interface 23 for interfacing with a micro-controller 31 external from the electrical power energy converter unit 10. Via the communication interface 23, a command signal is received from the micro-controller 31. After successfully transferring the command signal to the controller module 17, the external micro-controller 31 can be removed from the electrical power converter unit 10, for example by plugging the micro-controller 31 out of the communication interface 23, after which the electrical power converter unit 10 is ready for operational use.

On the one hand, the command signal defines which MPPT profile is selected out of the number of the MPPT profiles stored in the memory 21, for the controller module 17 to operate the DC-DC converting module 11 according to the selected MPPT profile. On the other hand, the command signal, the command signal comprises one or more additional MPPT profiles, not already present in the memory 21, wherein the controller module 17 is arranged to receive a command signal through the communication interface 23 for storing the respective MPPT profile or profiles in the memory 21 of the controller module 17.

The controller module 17 is operably coupled to the DC-DC converter module 11 and the sensor module 19 via bi-directional communication channels. This allows the controller module 17 to both change the MPPT profile parameters of the DC-DC converter module 11 and/or the sensor module 19, as well to receive the MPPT profile parameters of the DC-DC converter module 11 and/or the sensor module 19. This allows the controller module 17 to dynamically adapt a MPPT profile according to which the DC-DC converter module 11 is operated. Furthermore, the MPPT profile parameters can be outputted by the controller module 17, via the communication interface 23, to the external micro-controller 31.

The controller module 17 comprises a MPPT state machine for operating the selected MPPT profile. With the state machine the controller can make decisions within the MPPT profile to change any of the variables within the profile or the even change between one or multiple profiles. Depending on the MPPT profile the state machine comprises transitions between states of the state machine based on variables within the profile and/or based on data obtained from the sensor module 19.

FIG. 2 shows a schematic overview of another embodiment of the electrical power converter 10 according to the present disclosure, wherein some additional elements are shown. Elements in FIG. 2 with corresponding reference numbers correspond to elements in FIG. 1 as described above.

In addition to the elements shown in FIG. 1, the electrical power converter 10 of FIG. 2 furthermore comprises an oscillator 33 and an Analogue to Digital Converter, ADC, 35.

The switching frequency of the DC-DC converter module 11 is set by controlling the oscillator 33, based on a digital input, wherein the digital input is set by the controller module 17. For example, the oscillator frequency is doubled when the input is incremented by 1.

The ADC 35 is operably coupled to the controller module 17 and the sensor module 19 for readout of the sensor module 19 by the controller module 17. The readout can be communicated to the micro-controller 31 which is incidentally or permanently connected to the controller module 17.

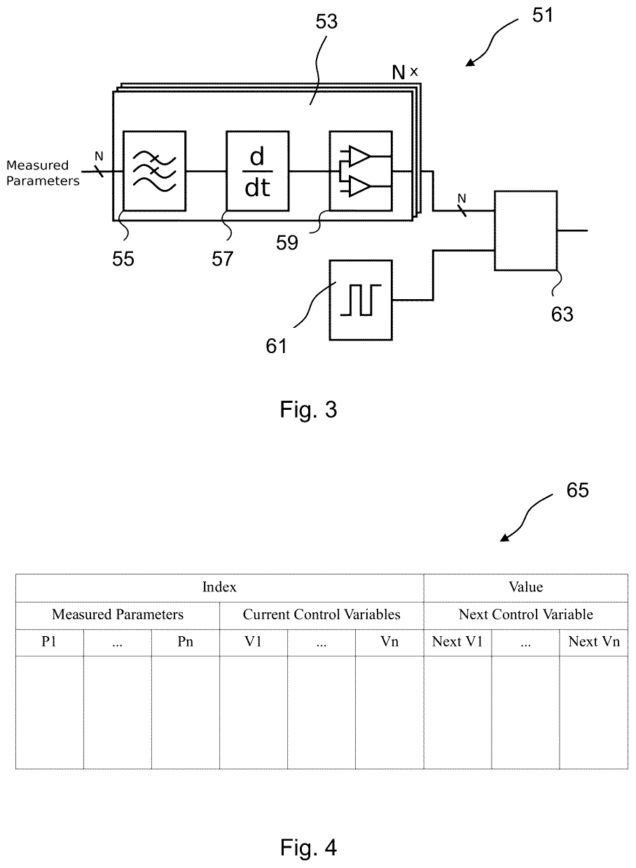

FIG. 3 shows a schematic overview of an event-based trigger 51 of an electrical power converter 10 according to the present disclosure. The controller module 17 of the electrical power energy converter 10 is arranged to receive one or more parameters N, wherein the parameters are one or more of the MPPT profile parameters as described above, but can also be the input voltage of the DC-DC converting module 11, the output voltage of the DC-DC converting module 11, the temperature of the DC-DC converting module 11 and the reflection coefficient of the RF energy harvesting module 13.

An event is characterized by a fast transition of one of the parameters N. The event-based triggering is used as the MPPT clock signal to speed up the MPPT when a fast transition of one of the parameters N is detected by the event-based trigger 51. The electrical power energy converter 10 can directly adapt to a fast change of input power and does not have to wait for the clock 61 comprised in the controller module 17. If the event does not happen, the MPPT will be activated by the clock 61, which typically has a very low clock frequency. As a result, the speed of convergence to the maximum power point increases while extremely reducing the power consumption of the electrical power energy converter 10. This allows a speed of convergence to the maximum power point independent of the clock frequency of the electrical power energy converter 10.

Each of the parameters N is connected to a transient detector 51. Each transient detector 51 comprises a low pass filter 55, a differentiator 57 and a window comparator 59 and generates an edge when a fast transient occurs. An edge detector 63 detects an edge in one of the N inputs thereof and generates an output signal in order to track the maximum power point. In case no edge is detected at one of the N inputs of the edge detector 63, a conventional MPPT algorithm is used at a clock frequency of the clock 61, that is typically low.

FIG. 4 shows a look-up table 65 for use by an MPPT algorithm of the event-based trigger 51. The loop-up table, LUT, 65 is for example stored in the memory 21 of the controller module 17, and is used to speed up the convergence to the maximum power point, MPP. Via the communication interface 23, the memory 21 is accessible by the micro-controller 31 in order to write to and/or read from the LUT 65. The LUT 65 is indexed by the measured parameters and the control variables. The set of control variables may contain any variable that modifies the state of the electrical power energy converter 10. Therefore, by changing values thereof, the electrical power energy converter 10 will get closer to or farther away from the MPP. The values in the table are related to the values that the control variables must assume so that the electrical power energy converter 10 operates in the MPP.

When there is a slow change of one of the parameters N, there is no point in using the LUT 65. In this case, the conventional MPPT algorithm is used with a slow clock signal. The complete

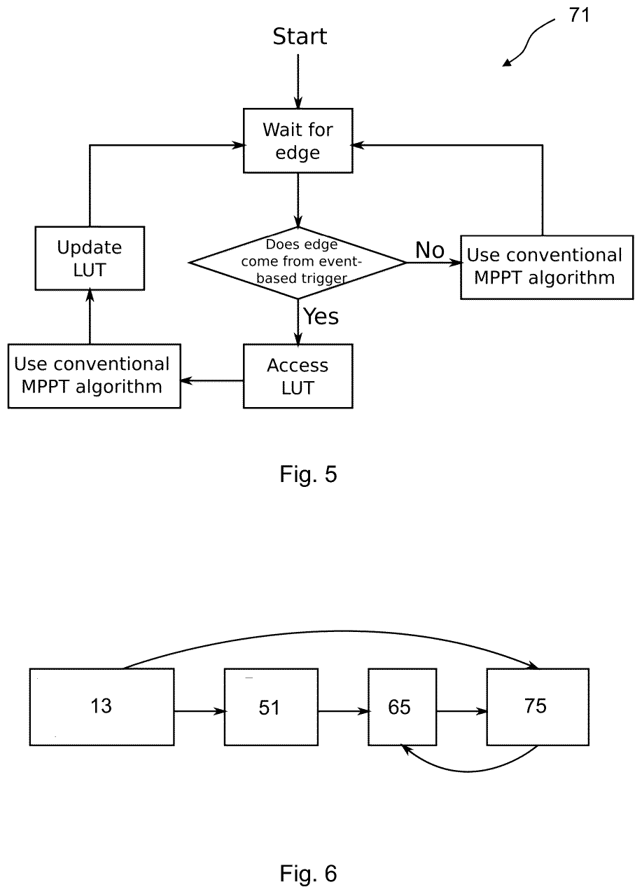

FIG. 5 shows a flow chart 71 of an MPPT algorithm of the event-based trigger 51. In a first step of the MPPT algorithm an edge is detected by the controller module 17. When the edge originates from the event-based trigger 51, with other words when the edge is triggered by a fast transient of one of the parameters N, the LUT 65 is accessed in order to control the DC-DC converter module 11 for operating in the MPP. Subsequently. After updating the LUT 65 by updating the next control variables, the algorithm waits for a new edge to be detected. When the edge does not originate from the event-based trigger 51, the conventional MPPT algorithm at the default clock frequency is executed, after which the algorithm waits for a new edge to be detected.

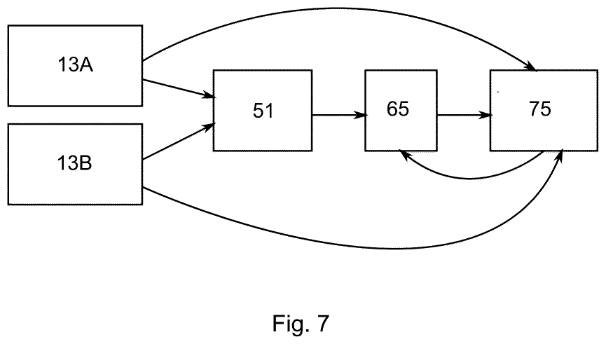

FIGS. 6 and 7 show a schematic overview of elements of embodiments of the electrical power converter 10 using the event-based trigger 51. In FIG. 6, a single energy harvesting module 13 is provided as in input for the power converter unit 10. In FIG. 7, two energy harvesting modules 13A, 13B are provided as in input for the power converter unit 10.

One or more parameters of the energy harvesting modules 13, 13A, 13B are provided as input to the event-based trigger 51 and to a LUT controller 75. The LUT controller 75 is comprised by the controller module 17, and is arranged for updating the LUT 65 based on the measured parameters of the energy harvesting modules 13, 13A, 13B and the current control variables of the LUT 65.

Expressions such as “comprise”, “include”, “incorporate”, “contain”, “is” and “have” are to be construed in a non-exclusive manner when interpreting the description and its associated claims, namely construed to allow for other items or components which are not explicitly defined also to be present. Reference to the singular is also to be construed in be a reference to the plural and vice versa.

Furthermore, the disclosure may also be embodied with less components than provided in the embodiments described here, wherein one component carries out multiple functions. Just as well may the disclosure be embodied using more elements than depicted in the Figures, wherein functions carried out by one component in the embodiment provided are distributed over multiple components.

Other variations to the disclosed embodiments can be understood and effected by those skilled in the art in practicing the claimed disclosure, from a study of the drawings, the disclosure, and the appended claims. In the claims, the word “comprising” does not exclude other elements or steps, and the indefinite article “a” or “an” does not exclude a plurality. A single stage of the circuit or other unit may fulfil the functions of several items recited in the claims. The mere fact that certain measures are recited in mutually different dependent claims does not indicate that a combination of these measured cannot be used to advantage. Any reference signs in the claims should not be construed as limiting the scope thereof.

What is claimed is:

1. An electrical power converter unit for converting Direct Current to Direct Current (DC-DC), the converter comprising:
a DC-DC converting module, arranged to convert a low-power direct current input signal received from an energy harvesting module, into a direct current output signal for powering a load;
a controller module, operably coupled to and arranged to control the DC-DC module, and arranged to convert the direct current input signal to the direct current output signal according to a Maximum Power Point Tracking (MPPT) profile, wherein the controller module comprises a memory for storing the MPPT profile and at least a further MPPT profile;
a sensor module operably coupled to controller module and the direct current output of the DC-DC converter module, and arranged to measure the direct current output to the load;
a communication interface, operably coupled to the controller module, arranged to interface with a micro-controller external from the electrical power energy converter unit to receive a command signal thereof, wherein the command signal defines which of the MPPT profile and at least one further MPPT profile selected for the controller module to operate the DC-DC converting module according to the selected MPPT profile.

2. The electrical power energy converter unit according to claim 1, wherein the controller module is arranged to receive a command signal through the interface, which command signal comprises the at least one further MPPT profile, to store the at least one further MPPT profile in the memory of the controller module.

3. The electrical power energy converter unit according to claim 1, wherein the controller module comprises a MPPT state machine to operate the selected MPPT profile.

4. The electrical power energy converter unit according to claim 1, wherein the memory of the controller module comprises a plurality of MPPT profiles to operate the DC-DC converter modules, and wherein each of the MPPT profiles provides an application specific operation of the electrical power energy converter unit.

5. The electrical power energy converter unit according to claim 1, wherein the MPPT profiles are arranged to change the operating of the DC-DC converter module by changing one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

6. The electrical power energy converter unit according to claim 1, wherein the controller module is arranged to dynamically adapt a MPPT profile according to which the DC-DC converter is operated, and wherein the controller module is arranged to receive one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

7. The electrical power energy converter unit according to claim 1, wherein the controller module is arranged to output to a micro-controller connected to the controller module one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

8. The electrical power energy converter unit according to claim 1, further comprising:
an Analogue to Digital Converter (ADC) operably coupled to the controller module and the sensor module for readout of the sensor module by the controller module and outputting the readout to a micro-controller connected to the controller module.

9. The electrical power energy converter unit according to claim 1, wherein the controller module is arranged to operate the DC-DC converter according to a MPPT profile in which the MPPT is bypassed.

10. The electrical power energy converter unit according to claim 2, wherein the controller module comprises a MPPT state machine to operate the selected MPPT profile.

11. The electrical power energy converter unit according to claim 2, wherein the memory of the controller module comprises a plurality of MPPT profiles to operate the DC-DC converter modules, and wherein each of the MPPT profiles provides an application specific operation of the electrical power energy converter unit.

12. The electrical power energy converter unit according to claim 2, wherein the MPPT profiles are arranged to change the operating of the DC-DC converter module by changing one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

13. The electrical power energy converter unit according to claim 2, wherein the controller module is arranged to dynamically adapt a MPPT profile according to which the DC-DC converter is operated, and wherein the controller module is arranged to receive one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

14. The electrical power energy converter unit according to claim 2, wherein the controller module is arranged to output to a micro-controller connected to the controller module one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.

15. The electrical power energy converter unit according to claim 2, further comprising:
an Analogue to Digital Converter (ADC) operably coupled to the controller module and the sensor module for readout of the sensor module by the controller module and outputting the readout to a micro-controller connected to the controller module.

16. The electrical power energy converter unit according to claim 2, wherein the controller module is arranged to operate the DC-DC converter according to a MPPT profile in which the MPPT is bypassed.

17. The electrical power energy converter unit according to claim 3, wherein the memory of the controller module comprises a plurality of MPPT profiles to operate the DC-DC converter modules, and wherein each of the MPPT profiles provides an application specific operation of the electrical power energy converter unit.

18. The electrical power energy converter unit according to claim 3, wherein the MPPT profiles are arranged to change the operating of the DC-DC converter module by changing one or more of:
a switching frequency of the DC-DC converter module;
a conversion ratio of the DC-DC converter module;
a number of parallel operating power switches comprised in the DC-DC converter module;
a resistor value of a resistor comprised in the sensor module;
a MPPT interval;
an overcurrent value; and
an undercurrent value.
